(19) United States
(12) Patent Application Publication
(10) Pub. No.: US 2024/0134170 A1
(43) Pub. Date: Apr. 25, 2024

(54) ULTRA-SHORT FOCUS PROJECTION LENS AND PROJECTION DEVICE

(71) Applicant: Coretronic Corporation, Hsin-Chu (TW)

(72) Inventors: Wei-Ting Wu, Hsin-Chu (TW); You-Da Chen, Hsin-Chu (TW); Ching-Chuan Wei, Hsin-Chu (TW)

(73) Assignee: Coretronic Corporation, Hsin-Chu (TW)

(21) Appl. No.: 18/487,136

(22) Filed: Oct. 16, 2023

(30) Foreign Application Priority Data
Oct. 17, 2022 (CN) 202211266587.1

(51) Int. Cl. G02B 13/16; G02B 13/18; G02B 17/08; G03B 21/14

(52) U.S. Cl. CPC G02B 13/16; G02B 13/18; G02B 17/08; G03B 21/14

(57) ABSTRACT

An ultra-short focus projection lens is configured to receive an image beam from an image source side and project the image beam toward a projection surface. The ultra-short focus projection lens has an optical axis. The ultra-short focus projection lens includes a reflective optical element, a first lens group, a stop, and a second lens group arranged in sequence along the optical axis. The image beam from the image source side passes through the second lens group, the stop, and the first lens group in sequence, and is reflected by the reflective optical element and projected to the projection surface. The first lens group includes a plurality of lenses having diopters. The second lens group 10 includes a plurality of lenses having diopters. The first lens group and the second lens group include ten lenses having diopters in total. A projection device is also provided.

### CROSS-REFERENCE TO RELATED APPLICATION

This application claims the priority benefit of China application serial no. 202211266587.1, filed on Oct. 17, 2022. The entirety of the above-mentioned patent application is hereby incorporated by reference herein and made a part of this specification.

### BACKGROUND OF THE INVENTION

### Field of the Invention

The invention relates to an optical lens and an optical device, and in particular to an ultra-short focus projection lens and a projection device.

### Description of Related Art

In the existing projection device using an ultra-short focus projection lens, the image beam from the light valve is formed into an intermediate image in the projection lens via at least a portion of the projection lens first, and then the image beam is projected onto a projection surface.

However, the ultra-short focus projection lens includes at least 14 lenses, and the production cost thereof is higher, and the length of the overall system is longer.

Moreover, due to the use of too many lenses, the mechanical design of the projection device is relatively complicated, and may not be applied to a small-sized projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides an ultra-short focus projection lens and a projection device using the ultra-short focus projection lens, wherein fewer lenses are used, such that the cost is lower, and the design is simple and suitable for projection devices of various sizes.

Other objects and advantages of the invention may be further understood from the technical features disclosed in the invention.

To achieve one or part or all of the above objects or other objects, an embodiment of the invention provides an ultra-short focus projection lens configured to receive an image beam from an image source side and project the image beam toward a projection surface. The ultra-short focus projection lens has an optical axis. The ultra-short focus projection lens includes a reflective optical element, a first lens group, a stop, and a second lens group arranged in sequence along the optical axis. After the image beam from the image source side passes through the second lens group, the stop, and the first lens group in sequence, the image beam is reflected by the reflective optical element and projected to the projection surface. The first lens group includes a plurality of lenses having diopters. The second lens group includes a plurality of lenses having diopters. The first lens group and the second lens group include ten lenses having diopters in total.

To achieve one or part or all of the above objects or other objects, an embodiment of the invention provides a projection device including an illumination system, a light valve, and an ultra-short focus projection lens. The illumination system is configured to provide an illumination beam. The light valve is disposed on a transmission path of the illumination beam and configured to convert the illumination beam into an image beam. The ultra-short focus projection lens is disposed on the transmission path of the image beam and configured to receive the image beam from the light valve and project the image beam toward a projection surface. The ultra-short focus projection lens has an optical axis. The ultra-short focus projection lens includes a reflective optical element, a first lens group, a stop, and a second lens group arranged in sequence along the optical axis. After the image beam from the light valve passes through the second lens group, the stop, and the first lens group in sequence, the image beam is reflected by the reflective optical element and projected to the projection surface. The first lens group includes a plurality of lenses having diopters. The second lens group includes a plurality of lenses having diopters. The first lens group and the second lens group include ten lenses having diopters in total.

Based on the above, in the ultra-short focus projection lens and projection device of an embodiment of the invention, the first lens group and the second lens group include ten lenses having diopters in total. Therefore, the ultra-short focus projection lens and the projection device use fewer lenses, such that the cost is lower, the mechanical design is easier, the overall system length is shorter, and the system volume is reduced. Due to the smaller number of lenses, the optical architectures of the ultra-short focus projection lens and the projection device are simple, and are applicable to projection devices of various sizes.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2 is a schematic diagram of the ultra-short focus projection lens in FIG. 1.

FIG. 3 is a schematic diagram of the ultra-short focus projection lens in FIG. 1 15 projecting an image beam on a projection surface.

FIG. 4 is a modulation transfer function diagram of the ultra-short focus projection lens of FIG. 2.

FIG. 5A to FIG. 5E are transverse ray fan plots of the ultra-short focus projection lens of FIG. 2 at different image heights, respectively.

FIG. 6A to FIG. 6E are spot diagrams of light of different wavelengths after passing through the ultra-short focus projection lens of FIG. 2 at different image heights.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

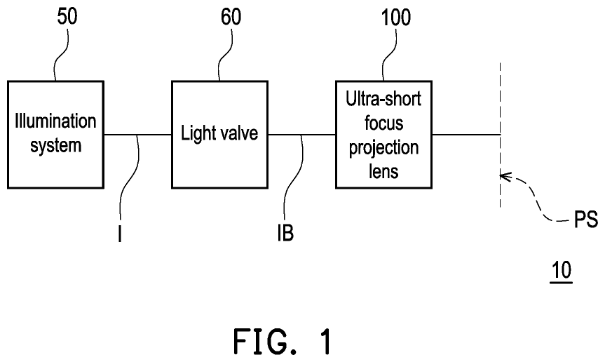

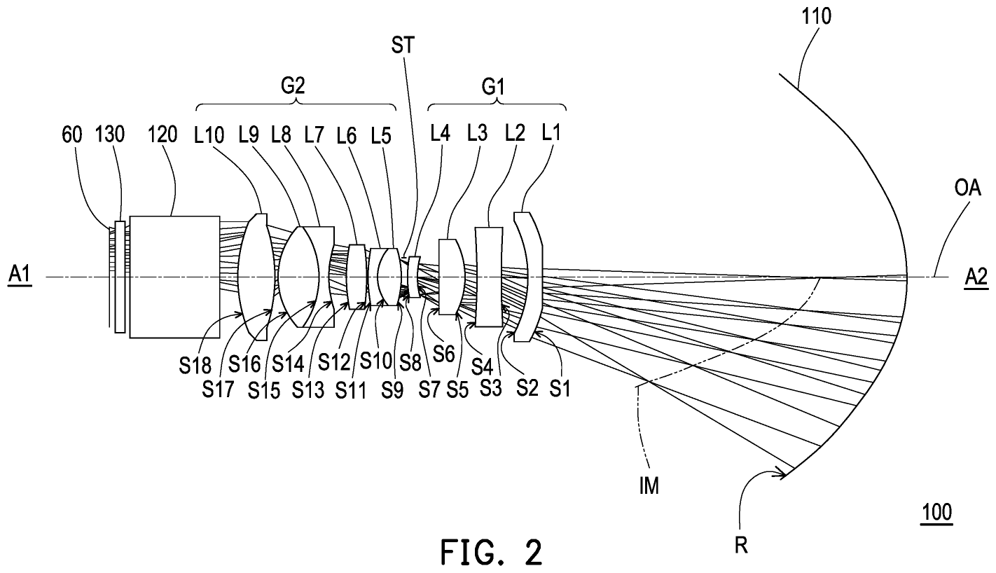

FIG. 1 is a schematic diagram of a projection device according to an embodiment of the invention. Please refer to FIG. 1, an embodiment of the invention provides a projection device 10 including an illumination system 50, a light valve 60, and an ultra-short focus projection lens 100. The illumination system 50 is configured to provide an illumination beam I. The light valve 60 is disposed on a transmission path of the illumination beam I and configured to convert the illumination beam I into an image beam IB. The ultra-short focus projection lens 100 is disposed on the transmission path of the image beam IB and configured to receive the image beam IB from the light valve 60 (an image source side A1 of FIG. 2) and project the image beam IB toward a projection surface PS.

Specifically, the illumination system 50 of the present embodiment includes, for example, a plurality of light-emitting elements, a wavelength conversion element, a light-homogenizing element, a light filter element, and a plurality of light splitting elements configured to provide light of different wavelengths as the source of the illumination beam I. The illumination system 50 includes, for example, a plurality of optical elements configured to collimate, converge, diverge, or change the transmission paths of light beams of different wavelengths. The optical elements are, for example, lenses and mirrors. In particular, the plurality of light-emitting elements are, for example, metal halide lamps, high-pressure mercury lamps, or solid-state illumination sources, such as light-emitting diodes or laser diodes. However, the invention does not limit the type or form of the illumination system 50 in the projection device 10, and sufficient teaching, suggestion, and implementation of the detailed structure and embodiments thereof may be obtained from common knowledge in the art, which are therefore not repeated herein.

In the present embodiment, the light valve 60 is, for example, a reflective light modulator such as a liquid crystal on silicon panel (LCoS panel) or a digital micro-minor device (DMD). In some embodiments, the light valve 60 may also be a transmissive light modulator such as a transparent liquid-crystal panel, an electro-optical modulator, a magneto-optic modulator, or an acousto-optic modulator (AOM). The invention does not limit the configuration and the type of the light valve 60. Regarding the method in which the light valve 60 converts the illumination beam I into the image bean IB, sufficient teaching, suggestion, and implementation of the detailed steps and embodiments thereof may be obtained from common knowledge in the art, which are therefore not repeated herein. In the present embodiment, the number of the light valve 60 is one, such as the projection device 10 using a single digital micromirror element, but in other embodiments, there may be a plurality, and the invention is not limited thereto.

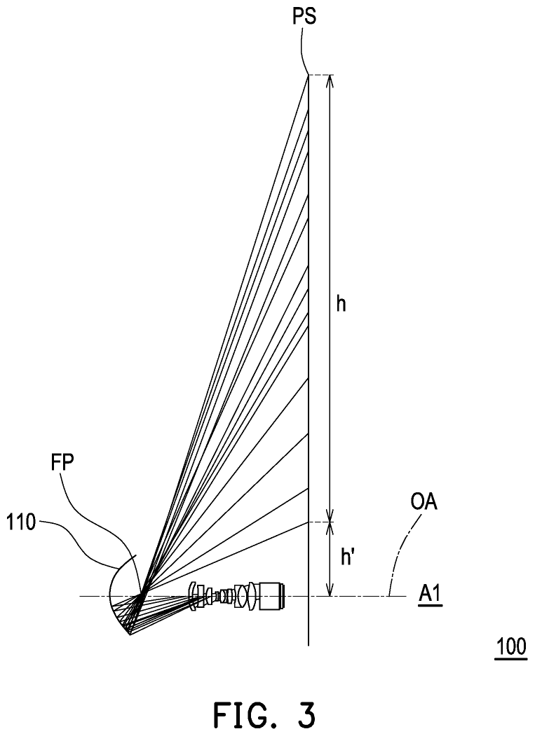

FIG. 2 is a schematic diagram of the ultra-short focus projection lens in FIG. 1. FIG. 3 is a schematic diagram of the ultra-short focus projection lens in FIG. 1 projecting an image beam on a projection surface. Please refer to FIG. 1 to FIG. 3, in the present embodiment, the ultra-short focus projection lens 100 has an optical axis OA. The ultra-short focus projection lens 100 includes a reflective optical element 110, a first lens group G1, a stop ST, and a second lens group G2 arranged in sequence along the optical axis OA. The light valve 60 is disposed on the image source side A1 of the ultra-short focus projection lens 100, and the reflective optical element 110 is located at a side A2 relative to the image source side A1, then after the image beam IB from the light valve 60 (the image source side A1) sequentially passes through the second lens group G2, the stop ST, and the first lens group G1, the image beam IB is reflected by the reflective optical element 110 and projected to the projection surface PS. The first lens group G1 includes a plurality of lenses L1, L2, L3, L4 arranged in sequence from the side A2 relative to the image source side Al to the image source side Al and having diopters. The second lens group G2 includes a plurality of lenses L5, L6, L7, L8, L9, L10 arranged in sequence from the side A2 relative to the image source side Al to the image source side Al and having diopters. The first lens group G1 and the second lens group G2 include ten lenses L1, L2, L3, L4, L5, L6, L7, L8, L9, and L10 having diopters in total.

In the present embodiment, each of the lenses L1 to L10 has a surface (surfaces S2, S4, S6, S8, S10, S11, S13, S15, S16, S18 respectively) which the image beam IB passes through facing the image source side Al and a surface (surfaces S1, S3, S5, S7, S9, S10, S12, S14, S15, S17 respectively) which the image beam IB passes through facing the side A2 relative to the image source side A1. The lenses L1 to L4 form the first lens group G1 and have negative, negative, positive, and negative diopters respectively, wherein the first lens group G1 has a negative diopter. The lenses L5 to L10 form the second lens group G2 and have positive, negative, positive, negative, positive, and positive diopters respectively, wherein the second lens group G2 has a positive diopter.

In the present embodiment, the lens L1 is a concave-convex lens having a convex surface facing the side A2, and the lens L1 is a plastic aspheric lens and has a negative diopter. The lens L2 is a biconcave lens, and the lens L2 is a glass spherical lens and has a negative diopter. The lens L3 is a convex-concave lens having a convex surface facing the side A2, and the lens L3 is a plastic aspheric lens and has a positive diopter. The lens L4 is a concave-convex lens having a convex surface facing the image source side A1, and the lens L4 is a glass spherical lens and has a negative diopter. The lens L5 and the lens L6 form a double cemented lens having a positive diopter. The lens L5 is a biconvex lens, and the lens L6 is a concave-convex lens having a convex surface facing the image source side A1. Both the lens L5 and the lens L6 are glass spherical lenses, and the lens L5 has a positive diopter and the lens L6 has a negative diopter. The lens L7 is a biconvex lens, and the lens L7 is a glass spherical lens and has a positive diopter. The lens L8 and the lens L9 form a double cemented lens having a negative diopter. The lens L8 is a biconcave lens, and the lens L9 is a biconvex lens. Both the lens L8 and the lens L9 are glass spherical lenses, and the lens L8 has a negative diopter and the lens L9 has a positive diopter. The lens L10 is a biconvex lens, and the lens L10 is a glass aspherical lens and has a positive diopter.

The data of a preferred embodiment of the ultra-short focus projection lens 100 are listed in Table 1 to Table 2 below. However, the data listed below are not intended to limit the invention. Any person skilled in the art may make appropriate changes to the parameters or settings after referring to the invention, which are still within the scope of the invention.

In the present embodiment, the actual design of the above elements may be seen in Table 1 below.

TABLE 1

| | | | Curva- | Dis- | Refractive | Abbe |
|---|---|---|---|---|---|---|
| | | | ture | tance | index | number |
| Element | Surface | Type | (1/mm) | (mm) | (Nd) | (Vd) |
| 110 | R | Aspheric | 17.95 | 40 | | |
| | | surface | | | | |
| L1 | S1 | Aspheric | 70.45 | 1.6 | 1.536 | 55.98 |
| | | surface | | | | |
| | S2 | Aspheric | 11.13 | 2.92 | | |
| | | surface | | | | |
| L2 | S3 | Spherical | −90.63 | 2.76 | 1.847 | 23.78 |
| | | surface | | | | |
| | S4 | Spherical | 68.93 | 1.36 | | |
| | | surface | | | | |
| L3 | S5 | Aspheric | 11.3 | 2.83 | 1.536 | 55.98 |
| | | surface | | | | |
| | S6 | Aspheric | −170.28 | 2.34 | | |
| | | surface | | | | |
| L4 | S7 | Spherical | −6.58 | 1 | 1.835 | 37.09 |
| | | surface | | | | |
| | S8 | Spherical | −15.97 | 0.51 | | |
| | | surface | | | | |
| ST | | Plane | Infinity | 0.2 | | |
| L5 | S9 | Spherical | 11.6 | 2.66 | 1.647 | 32.28 |
| | | surface | | | | |
| L6 | S10 | Spherical | −4.74 | 1 | 1.803 | 38.35 |
| | | surface | | | | |
| | S11 | Spherical | −16.78 | 0.2 | | |
| | | surface | | | | |
| L7 | S12 | Spherical | 31.73 | 2.20 | 1.824 | 24.33 |
| | | surface | | | | |
| | S13 | Spherical | −22.02 | 1.95 | | |
| | | surface | | | | |
| L8 | S14 | Spherical | −11.84 | 1.01 | 1.903 | 20.36 |
| | | surface | | | | |
| L9 | S15 | Spherical | 10.62 | 4.60 | 1.516 | 54.15 |
| | | surface | | | | |
| | S16 | Spherical | −8.55 | 0.2 | | |
| | | surface | | | | |
| L10 | S17 | Aspheric | 13.17 | 4.26 | 1.516 | 64.07 |
| | | surface | | | | |
| | S18 | Aspheric | −18.07 | 1.81 | | |
| | | surface | | | | |

In Table 1, the lens L1 has the surface S1 and the surface S2 sequentially from the side A2 to the image source side A1, and the lens L2 has the surface S3 and the surface S4 sequentially from the side A2 to the image source side A1. By analogy, the surface corresponding to each element is not described again. In particular, the lens L5 and the lens L6 are a set of cemented lenses, so the surface S10 of the lens L5 facing the image source side A1 is the same surface as the surface S10 of the lens L6 facing the side A2. In addition, in Table 1, “distance” refers to the distance between two adjacent surfaces on the optical axis OA. For example, the distance corresponding to the surface S1 refers to the distance between the surface Si and the surface S2 on the optical axis OA, and the distance corresponding to the surface S2, that is, the linear distance between the surface S2 and the surface S3 on the optical axis OA is analogized as such.

In the present embodiment, a reflective surface R of the reflective optical element 110, the surface S1 and the surface S2 of the lens L1, the surface S5 and the surface S6 of the lens L3, and the surface S17 and the surface S18 of the lens L10 are all aspherical surfaces, and the surfaces of the remaining lenses (the lens L2 and the lenses L4 to L9) are all spherical. Equation (1) for the aspheric surface is as follows:

$$x = \frac{{c}^{{′y}^{2}}}{1 + \sqrt{1 - ( 1 + K ) {c}^{′2} {y}^{2}}} + {A}^{′} {y}^{2} + {Ay}^{4} + {By}^{6} + {Cy}^{8} + {Dy}^{10} + {Ey}^{12} + {Fy}^{14} + {Gy}^{16} … \qquad Equation ( 1 )$$

In Equation (1), x is the shift (sag) in the direction of the optical axis, c′ is the reciprocal of the radius of the osculating sphere, that is, the reciprocal of the radius of curvature near the optical axis OA, K is the quadratic coefficient, and y is the height of the aspheric surface, which is the height from the center of the lens to the edge of the lens. A to G respectively represent aspheric coefficients of each order of the aspheric polynomial. Table 2 lists the parameter values of the reflective surface R of the reflective optical element 110, the surface S1 and the surface S2 of the lens L1, the surface S5 and the surface S6 of the lens L3, and the surface S17 and the surface S18 of the lens L10, wherein the second-order aspheric coefficients A′ are all 0.

TABLE 2

| | R | S1 | S2 | S5 | S6 |
|---|---|---|---|---|---|
| K | −8.44E−01 | 0 | 0 | 0 | 0 |
| A | −7.77E−06 | 0.000496 | −8.72E−05 | 0.000611 | 0.000838 |
| B | 9.01E−09 | −7.56E−06 | −2.11E−05 | −2.28E−05 | −2.92E−05 |
| C | 3.62E−12 | 4.31E−07 | 1.69E−06 | 5.12E−06 | 9.90E−06 |
| D | −2.78E−15 | −1.19E−08 | −6.83E−08 | −6.24E−07 | −2.53E−06 |
| E | −1.48E−17 | 1.32E−10 | 8.80E−10 | 2.51E−08 | 2.36E−07 |
| F | 1.98E−20 | −5.50E−13 | 6.36E−12 | −4.94E−12 | −6.49E−09 |
| G | 0 | 4.18E−15 | −1.50E−13 | −1.05E−11 | −4.52E−11 |

| | S17 | S18 |
|---|---|---|
| K | 0 | 0 |
| A | −0.00026 | −3.18E−05 |
| B | −1.07E−06 | −1.82E−06 |
| C | −3.27E−08 | 2.59E−08 |
| D | −1.41E−09 | −1.38E−09 |
| E | 2.91E−11 | −3.33E−11 |
| F | −1.64E−12 | 1.78E−13 |
| G | | |

In the present embodiment, the fixed-focus projection lens module 100 further includes the stop ST. As shown in FIG. 2, the stop ST is located between the lens L4 and the lens L5 on the optical axis OA.

In the present embodiment, the ultra-short focus projection lens 100 further includes a prism 120 and a cover glass 130 in sequence along the optical axis OA from the side A2 to the image source side Al. The prism 120 and the cover glass 130 are located between the lens L10 and the light valve 60 on the optical axis OA, and the cover glass 130 is located between the light valve 60 and the prism 120 on the optical axis OA.

In the present embodiment, the first lens group G1 includes four lenses L1, L2, L3, L4 having diopters, and the second lens group G2 includes six lenses L5, L6, L7, L8, L9, L10 having diopters.

In the present embodiment, the first lens group G1 and the second lens group G2 form a focusing group. When the ultra-short focus projection lens 100 is focusing, the focusing group (the first lens group G1 and the second lens group G2) is moved along the optical axis OA, in order to make the image formed by the image beam IB projected on the projection surface PS clearer.

In the present embodiment, the image beam IB forms an intermediate image IM between the first lens group G1 and the reflective optical element 110.

In the present embodiment, the reflective surface R of the reflective optical element 110 is a concave surface facing the first lens group G1 and has a negative diopter, wherein the concave surface is an aspheric surface or a free-form surface.

In the present embodiment, the plurality of lenses L1, L2, L3, and L4 of the first lens group G1 include at least one plastic aspheric lens, and one of the lenses L1, L2, L3, L4 is an aspheric lens having a negative diopter, such as the lenses L1, L3. Moreover, in the plurality of lenses L1, L2, L3, L4 of the first lens group Gl, the lens L1 closest to the reflective optical element 110 and the lens L4 closest to the stop ST both have negative diopters, wherein the lens group closest to the stop ST in the first lens group G1 also has a negative diopter. For example, the lens group formed by the lens L4 and the lens L3 has a negative diopter, or the lens group formed by the lens L4, the lens L3, and the lens L2 also has a negative diopter. In addition, the first lens group G1 closest to the reflective optical element 110 has a negative diopter.

In the present embodiment, the plurality of lenses L5, L6, L7, L8, L9, and L10 of the second lens group G2 are all glass lenses, and the lenses L5, L6, L7, L8, L9, and L10 include at least one aspheric lens, such as the lens L10. The second lens group G2 includes two double cemented lenses, such as a cemented lens formed by the lens L5 and the lens L6 and another cemented lens formed by the lens L8 and the lens L9. One of the lenses L5, L6, L7, L8, L9, and L10 of the second lens group G2 is a positive diopter glass aspheric lens, such as the lens L10. Moreover, one of the lenses L5, L6, L7, L8, L9, L10 of the second lens group G2 is a glass lens having a refractive index greater than 1.9, such as the lens L8.

In the present embodiment, as shown in FIG. 3, the image source side A1 and the projection surface PS are located at the same side of the ultra-short focus projection lens 100. After the image beam IB is reflected by the reflective optical element 110, one focus point FP is formed between the reflective optical element 110 and the projection surface PS.

In the present embodiment, the projection device 10 complies with: (h+h′)/h>125%, wherein h is the length of the image range formed by the image beam IB projected on the projection surface PS along the direction of the vertical optical axis OA, and h′ is the distance along the direction perpendicular to the optical axis OA between the lower edge of the image range formed by the image beam IB projected on the projection surface PS and the optical axis OA. When the projection device 10 satisfies the above relationship of (h+h′)/h>125%, the image beam IB may be prevented from being blocked by the projection device 10 on the transmission path projected to the projection surface PS.

In the present embodiment, the ultra-short focus projection lens 100 is a telecentric projection lens.

In the present embodiment, the ultra-short focus projection lens 100 complies with: half field of view (HFOV)>70 degrees, so that the ultra-short focus projection lens 100 is an ultra-wide-angle lens.

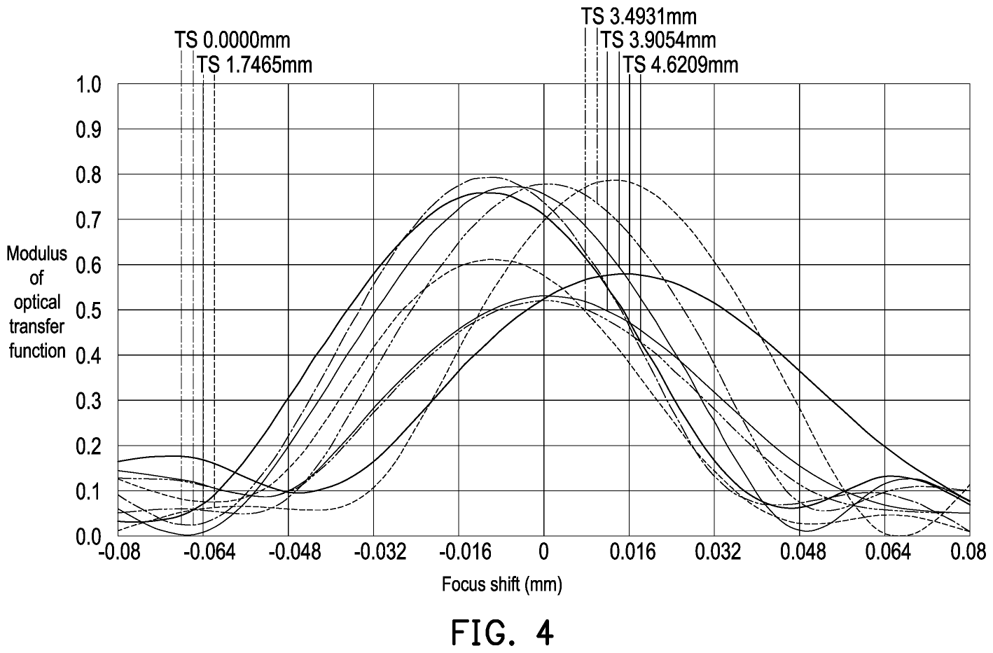

FIG. 4 is a modulation transfer function diagram of the ultra-short focus projection lens of FIG. 2. In FIG. 4, the spatial frequency is 93.0000 cycles/mm, and the figure is the modulation transfer function (MTF) diagram of the ultra-short focus projection lens 100 at different image heights, wherein the horizontal axis is the focus shift, the vertical axis is the modulus of the optical transfer function, T represents the curve in the tangential direction, S represents the curve in the sagittal direction, and the value marked next to “TS” represents the image height. It may be verified from FIG. 4 that the optical transfer function curve displayed by the ultra-short focus projection lens 100 of the present embodiment is within the standard range, so good optical imaging quality is achieved.

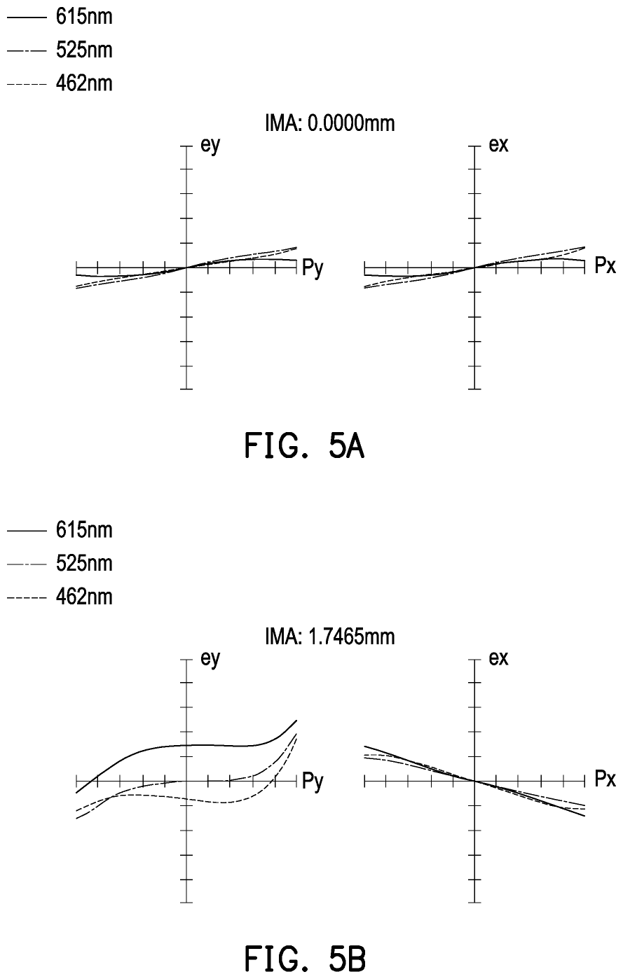

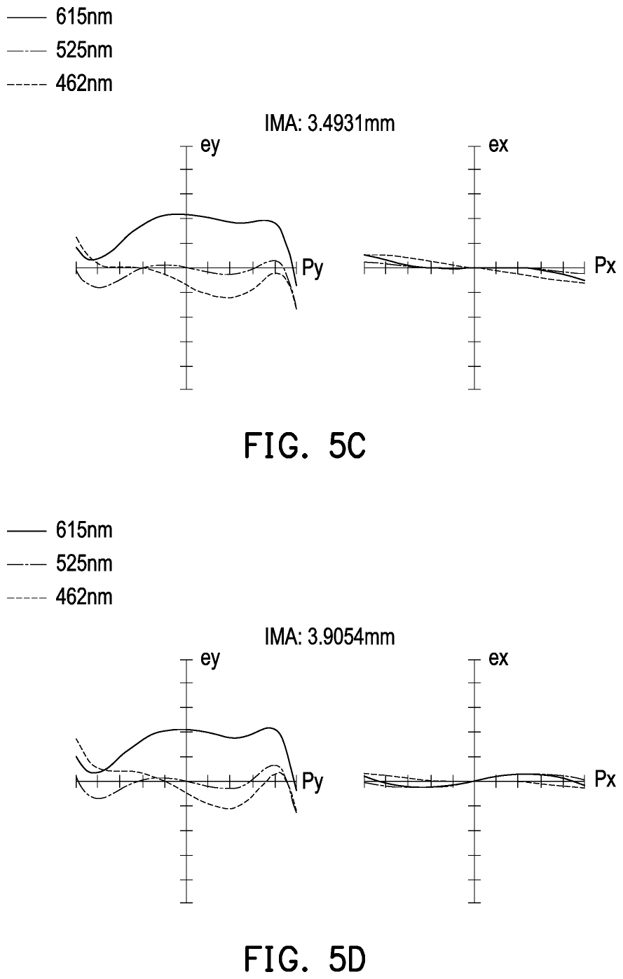

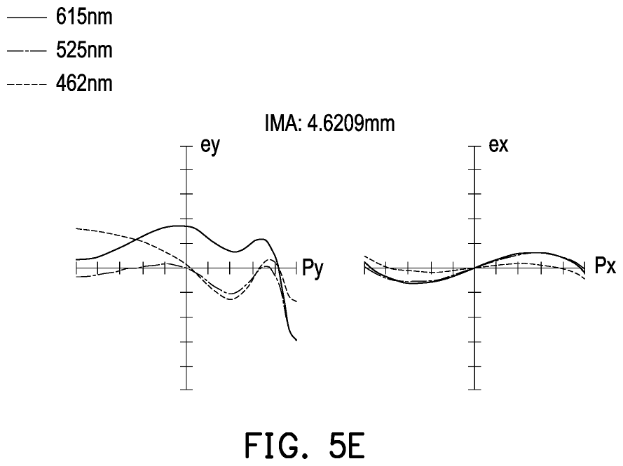

FIG. 5A to FIG. 5E are the transverse ray fan plots of the ultra-short focus projection lens of FIG. 2 at different image heights, respectively, wherein the maximum and minimum scales of the ex, ey, Px, and Py axes are respectively ±1 (normalized). Please refer to FIG. 5A to FIG. 5E, the graphs shown in FIG. 5A to FIG. 5E are all within the standard range, so it may be verified that the ultra-short focus projection lens 100 of the present embodiment may achieve good optical imaging quality.

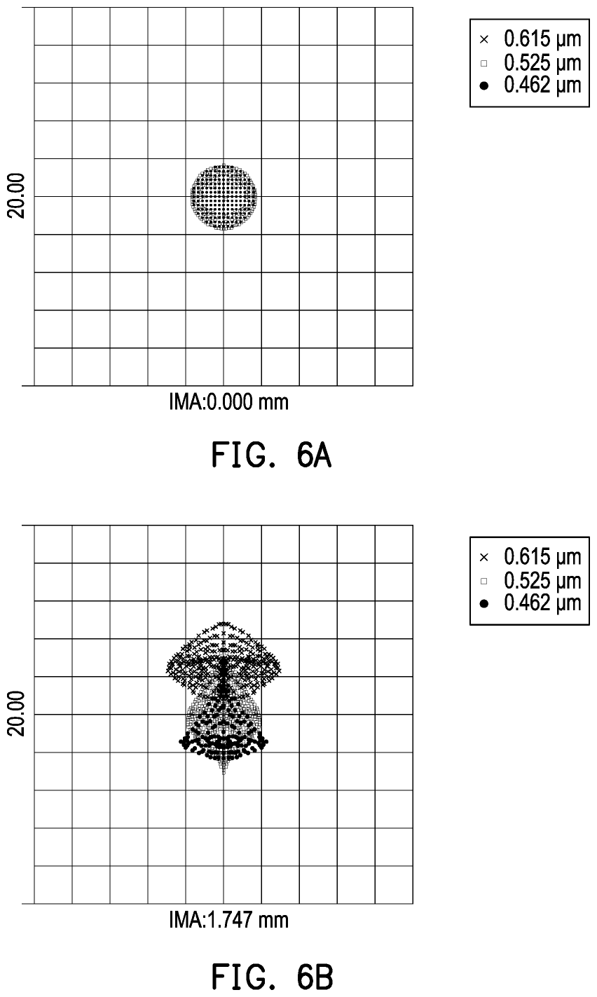

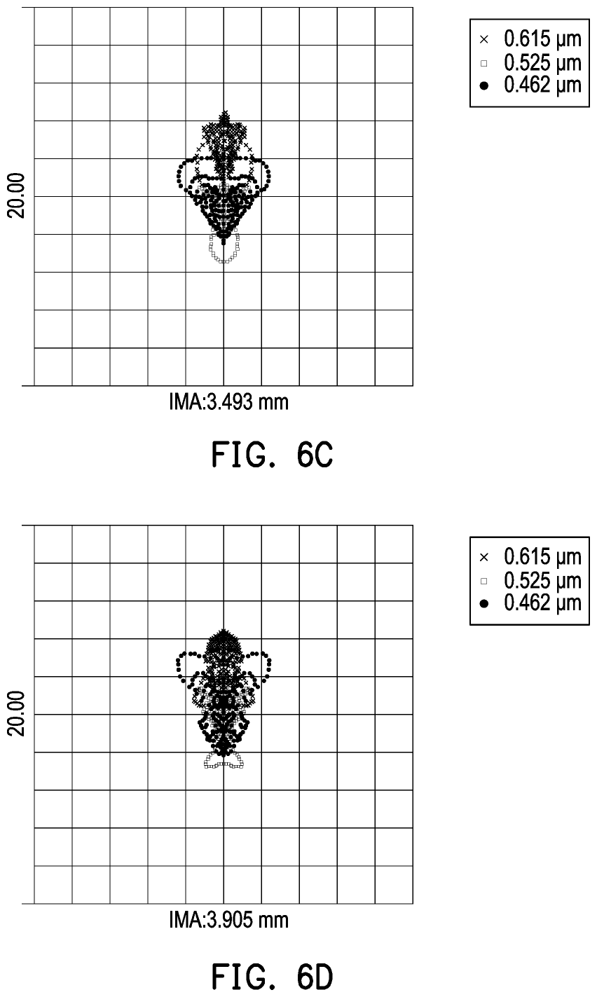

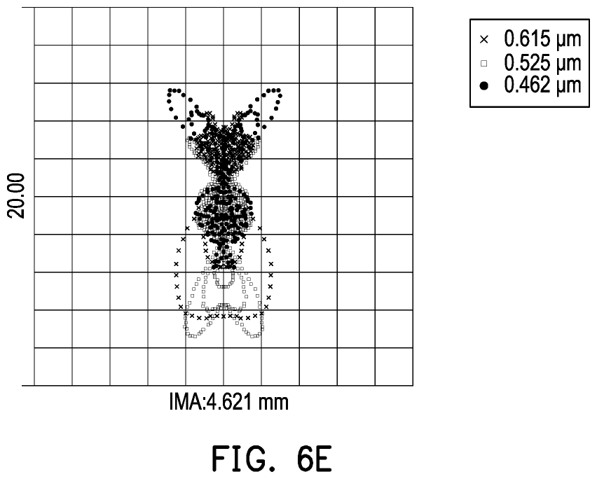

FIG. 6A to FIG. 6E are spot diagrams of light of different wavelengths after passing through the ultra-short focus projection lens of FIG. 2 at different image heights, wherein the maximum range of x-axis and y-axis is 20 microns. Please refer to FIG. 6A to FIG. 6E, the light spots of light of each wavelength after passing through the ultra-short focus projection lens 100 are all not too large. Therefore, the image projected by the ultra-short focus projection lens 100 of the present embodiment has a higher imaging quality.

Based on the above, in the ultra-short focus projection lens and the projection device of an embodiment of the invention, the first lens group includes a plurality of lenses having diopters, the second lens group includes a plurality of lenses having diopters, and the first lens group and the second lens group include ten lenses having diopters in total. Therefore, the ultra-short focus projection lens and the projection device use fewer lenses, so that the cost is lower, the mechanical design is easier, the overall system length is shorter, and the system volume is reduced. Due to the smaller number of lenses, the optical architectures of the ultra-short focus projection lens and the projection device are simple, and are applicable to projection devices of various sizes.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An ultra-short focus projection lens, configured to receive an image beam from an image source side and project the image beam toward a projection surface, wherein the ultra-short focus projection lens has an optical axis, the ultra-short focus projection lens comprises a reflective optical element, a first lens group, a stop, and a second lens group arranged in sequence along the optical axis, after the image beam from the image source side passes through the second lens group, the stop, and the first lens group in sequence, the image beam is reflected by the reflective optical element and projected to the projection surface; wherein,
the first lens group comprises a plurality of lenses having diopters;
the second lens group comprises a plurality of lenses having diopters; and
the first lens group and the second lens group comprise ten lenses having diopters in total.

2. The ultra-short focus projection lens of claim 1, wherein a reflective surface of the reflective optical element is a concave surface facing the first lens group and has a negative diopter, and the concave surface is an aspherical surface or a free-form surface.

3. The ultra-short focus projection lens of claim 1, wherein the first lens group and the second lens group form a focusing group configured to be moved along the optical axis when the ultra-short focus projection lens is focusing.

4. The ultra-short focus projection lens of claim 1, wherein the image beam forms an intermediate image between the first lens group and the reflective optical element.

5. The ultra-short focus projection lens of claim 1, wherein after the image beam is reflected by the reflective optical element, a focal point is formed between the reflective optical element and the projection surface.

6. The ultra-short focus projection lens of claim 1, wherein the image source side and the projection surface are located at a same side of the ultra-short focus projection lens.

7. The ultra-short focus projection lens of claim 1, wherein the ultra-short focus projection lens is a telecentric projection lens.

8. The ultra-short focus projection lens of claim 1, wherein the ultra-short focus projection lens complies with: half field of view >70 degrees.

9. The ultra-short focus projection lens of claim 1, wherein the plurality of lenses of the first lens group comprise at least one piece of plastic aspherical lens.

10. The ultra-short focus projection lens of claim 1, wherein in the plurality of lenses of the first lens group, a lens closest to the reflective optical element and a lens closest to the stop both have negative diopters.

11. The ultra-short focus projection lens of claim 1, wherein the first lens group has a negative diopter.

12. The ultra-short focus projection lens of claim 1, wherein one of the plurality of lenses of the first lens group is an aspheric lens with a negative diopter.

13. The ultra-short focus projection lens of claim 1, wherein the plurality of lenses of the second lens group are all glass lenses, and the plurality of lenses comprise at least one aspherical lens.

14. The ultra-short focus projection lens of claim 1, wherein the second lens group comprises two double cemented lenses.

15. The ultra-short focus projection lens of claim 1, wherein one of the plurality of lenses of the second lens group is a glass aspheric lens with a positive diopter.

16. The ultra-short focus projection lens of claim 1, wherein one of the plurality of lenses of the second lens group is a glass lens with a refractive index greater than 1.9.

17. The ultra-short focus projection lens of claim 1, wherein the first lens group comprises four lenses having diopters, and the second lens group comprises six lenses having diopters.

18. A projection device, wherein the projection device comprises an illumination system, a light valve, and an ultra-short focus projection lens, wherein:
the illumination system is configured to provide an illumination beam;
the light valve is disposed on a transmission path of the illumination beam and configured to convert the illumination beam into an image beam; and
the ultra-short focus projection lens is disposed on a transmission path of the image beam and configured to receive the image beam from the light valve and project the image beam toward a projection surface, the ultra-short focus projection lens has an optical axis, the ultra-short focus projection lens comprises a reflective optical element, a first lens group, a stop, and a second lens group arranged in sequence along the optical axis, after the image beam from the light valve passes through the second lens group, the stop, and the first lens group in sequence, the image beam is reflected by the reflective optical element and projected to the projection surface; wherein,
the first lens group comprises a plurality of lenses having diopters;
the second lens group comprises a plurality of lenses having diopters; and
the first lens group and the second lens group comprise ten lenses having diopters in total.

19. The projection device of claim 18, wherein the projection device complies with: (h+h′)/h>125%, wherein h is a length of an image range formed by the image beam projected on the projection surface along a direction perpendicular to the optical axis, and h′ is a distance along a direction perpendicular to the optical axis between a lower edge of the image range formed by the image beam projected on the projection surface and the optical axis.

20. The projection device of claim 18, wherein the first lens group and the second lens group form a focusing group configured to be moved along the optical axis when the ultra-short focus projection lens is focusing.
